(19) United States
(12) Patent Application Publication
(10) Pub. No.: US 2006/0060037 A1
(43) Pub. Date: Mar. 23, 2006

(54) Hand-held-wrench stand and stabilizer

(76) Inventor: Michael L. Haggerty, Grosse Pointe Woods, MI (US)

Correspondence Address: Christopher J. Fildes;Fildes & Outland, P.C., Suite 2, 20916 Mack Avenue, Grosse Pointe Woods, MI, 48236, US

(21) Appl. No.: 11/223,563

(22) Filed: Sep. 9, 2005

Related U.S. Application Data
(60) Provisional application No. 60/611,991, filed on Sep. 22, 2004.

(51) Int. Cl. B25B 23/00

(52) U.S. Cl. 81/462

(57) ABSTRACT

A wrench stand for supporting a hand-held tool in a use position. The stand includes a laterally and longitudinally extending base member having an upper surface and a lower surface. The stand also includes an elongated, longitudinally extending tool-handle receiver disposed on the upper surface.

### CROSS REFERENCE TO RELATED APPLICATION

This application claims the benefit of U.S. Provisional Application No. 60/611,991, filed Sep. 22, 2004.

### TECHNICAL FIELD

This invention relates to hand-held tools for turning and twisting objects and, more particularly, to a stand for supporting and stabilizing a wrench on a surface.

### BACKGROUND OF THE INVENTION

Hand-held tools including pipe wrenches, adjustable wrenches, locking pliers and others are used for effecting connections, either tightening or loosening, between mechanically connectable apparatus such as pipes and fittings and nuts and bolts. These connections require one part or piece to be rotated relative to a connectable part or piece. Often a plumber or mechanic acting alone must operate two wrenches simultaneously in different rotational directions. The ground or other supporting surface is often used to provide the resistive force of one wrench against the rotation force of another wrench. When there is an interruption in wrench support, such as occurs when the wrench on the ground falls over, there is a loss of resistance which allows the other wrench to rotate freely resulting in loss of force to the pieces being connected or disconnected and often times injury to the plumber or mechanic.

For example, threaded pipes are joined together using couplings or fittings between threaded pipe ends. In order to adequately tighten a coupling on a threaded pipe end, a pair of pipe wrenches are often used. One of the wrenches is used to clamp the pipe and prevent rotation of the pipe while the other of the wrenches is used to clamp and turn the coupling onto the threads of the pipe end. Oftentimes, the wrench used for clamping the pipe is placed on the floor and held in an unstable, upward jaw facing position by a worker's hand or foot. While the pipe wrench is in this unstable position, it tends to slip and may tip over onto the ground resulting in worker injury. In addition, each time a pipe wrench tips over, it must be set up again to clamp the pipe and continue the process.

The removal of a coupling from a threaded pipe end is also accomplished using a pair of pipe wrenches. One of the wrenches is used to clamp the pipe and prevent rotation of the pipe while the other of the wrenches is used to clamp and turn the coupling off the threads of the pipe end. Oftentimes, the wrench used for clamping the pipe is placed on the floor and held by a worker's hand or foot. However, as previously discussed the pipe wrench used for clamping the pipe oftentimes slips or tips over.

### SUMMARY OF THE INVENTION

The present invention provides a wrench stand for supporting a hand-held tool in a use position. When the hand-held tool is a pipe wrench, the wrench is held in a stabilized position for clamping and preventing rotation of a pipe.

In an exemplary embodiment of the present invention, a wrench stand for supporting a hand-held tool in a use position includes a laterally and longitudinally extending base member having an upper surface and a lower surface. A first side wall is rigidly attached to the base. The first side wall extends longitudinally relative to the base and projects upwards from the upper surface of the base. A second side wall is rigidly attached to the base. The second side wall extends longitudinally relative to the base and projects upwards from the upper surface of the base. The first and second side walls form a longitudinally extending slot therebetween in which the tool can be disposed and supported in the use position.

Optionally, the second side wall of the wrench stand may angle toward and away from the first side wall to create a slot. The slot may have a width which varies over a length of the slot allowing for various sized tool handles to be disposed in and supported by the wrench stand. The slot of the wrench stand may include first and second slot openings at opposing ends of the slot. The first slot opening may be wider than the second slot opening.

The second side wall of the wrench stand may be rigidly attached to the base at a first end portion of the second side wall adjacent the first slot opening. The second side wall may be flexibly attached to the base at a second end portion of the side wall adjacent the second slot opening. The flexibility of the second end portion enables a greater variety of tool handles to be received at the second slot opening.

The wrench stand may include a longitudinally extending L-shaped member having a first leg and a second leg. The first leg may be connected to the upper surface of the base member and the second leg may define the first side wall.

The wrench stand may be a welded assembly. Alternatively, the first and second side walls may be integrally attached to the base member. The wrench stand may even be a single piece structure and may be formed of injection molded plastic or cast metal.

In an alternative embodiment of the present invention, a wrench stand for supporting a hand-held tool in a use position includes a laterally and longitudinally extending base member having an upper surface and a lower surface. An elongated, longitudinally extending tool-handle receiver is disposed on the upper surface.

Optionally, the receiver of the wrench stand may include first and second side walls extending from the base upper surface and defining a slot therebetween. The first and second side walls may be non-parallel, and the slot may have a width that varies over a length of the slot.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a wrench stand in accordance with the present invention in which a wrench is disposed in one end of the wrench stand;

FIG. 2 is a top view of the wrench stand of FIG. 1;

FIG. 3 is a rear view of the wrench stand of FIG. 1;

FIG. 4 is a side view of the wrench stand of FIG. 1;

FIG. 5 is a bottom view of the wrench stand of FIG. 1; and

FIG. 6 is a perspective view of the wrench stand of FIG. 1 in which a wrench is disposed in an opposing end of the wrench stand.

### DETAILED DESCRIPTION OF THE INVENTION

Referring now to the drawings in detail, numeral 10 generally indicates a wrench stand for supporting a hand-held tool 12 in a use position. For example, when the hand-held tool 12 is a pipe wrench, the wrench stand 10 holds the wrench in a stabilized position for clamping and preventing rotation of a pipe 14 relative to the wrench while a fitting coupled to the pipe 14 is torqued by a second wrench 15.

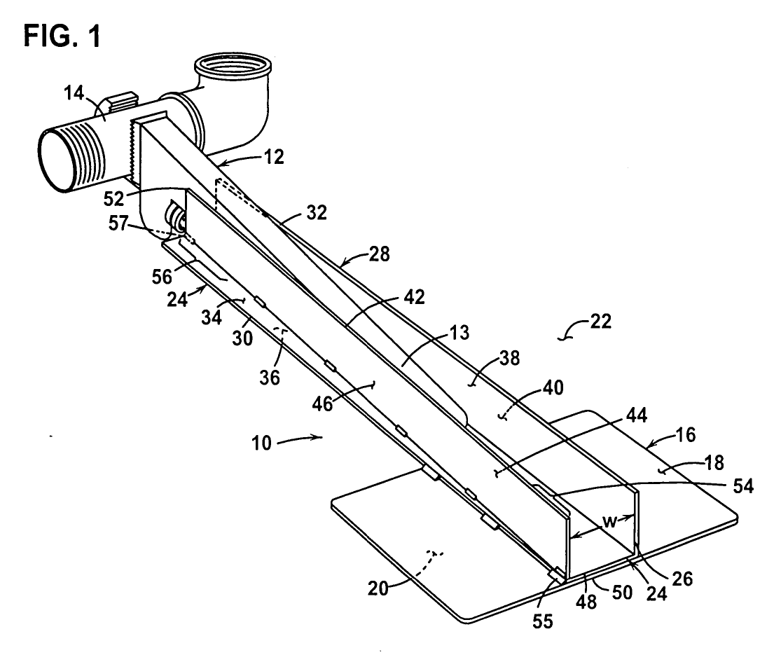

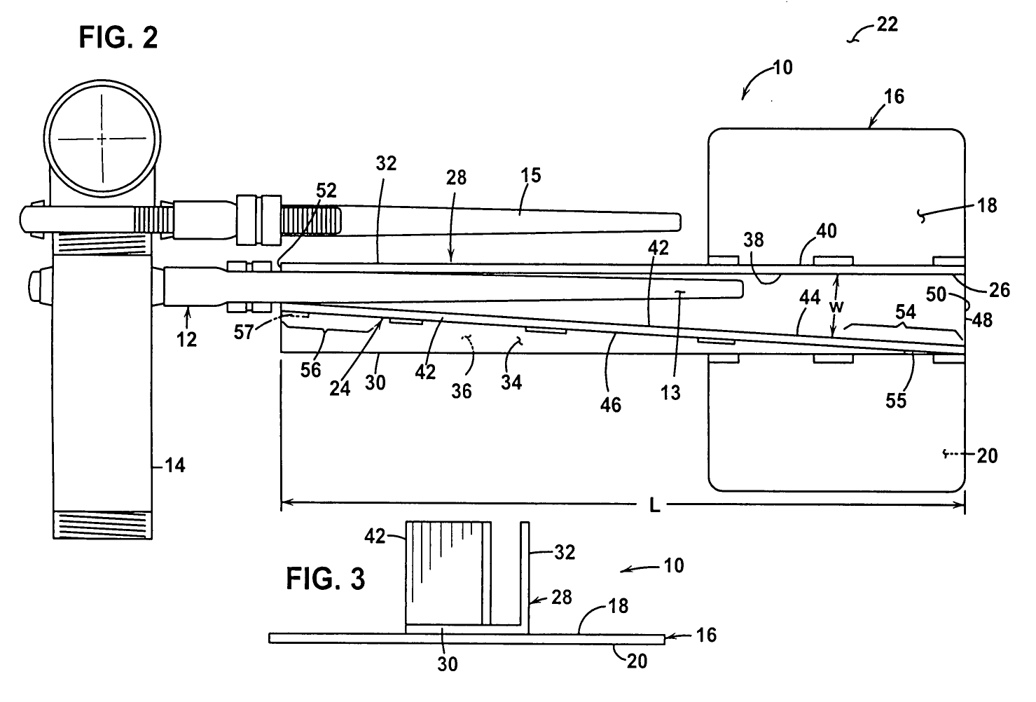

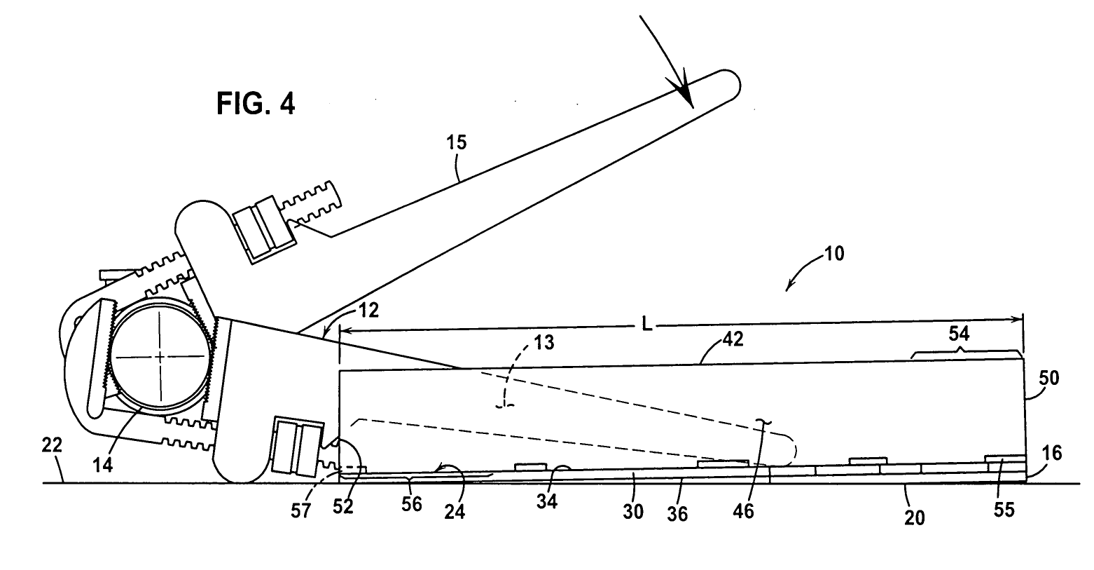

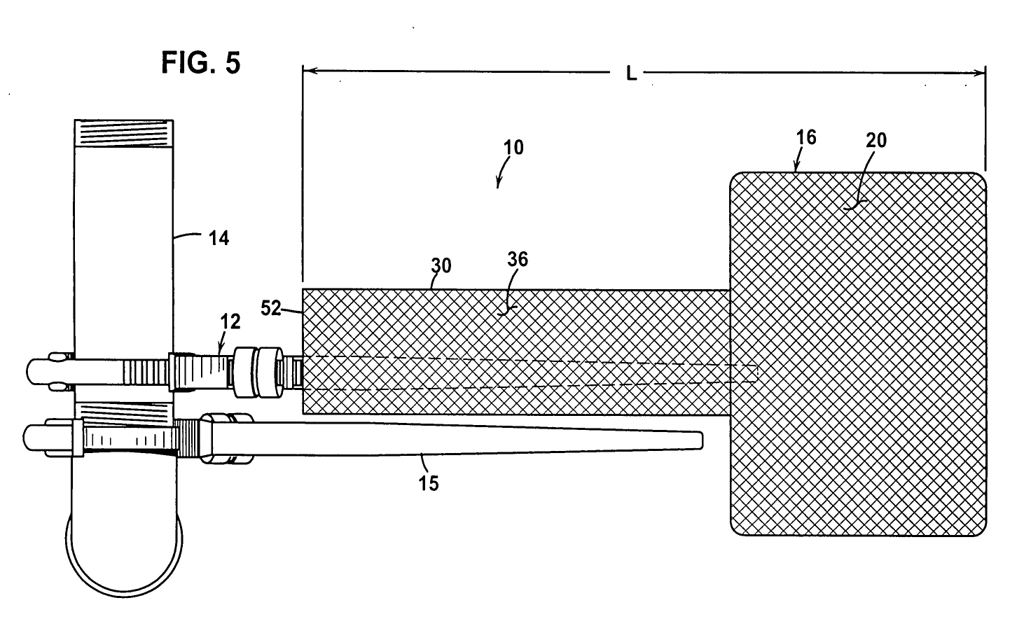

With reference to FIGS. 1-5, according to the invention, the wrench stand 10 includes a laterally and longitudinally extending base member 16 including upper and lower surfaces 18 and 20 and is formed of a rigid material adapted to be disposed on a supporting surface 22. The wrench stand 10 also includes an elongated tool handle receiver 24 on the upper surface 18 of the base member 16 in which a tool handle 13 of the hand held wrench 12 is receivable. The lower surface 20 of the base member may be made skid or scuff resistant through the application of a slip-resistant material or coating or as the result of mechanical working (e.g., machining).

The tool handle receiver 24 includes an elongated, generally U-shaped slot 26. In one embodiment, the tool handle receiver 24 is defined by a longitudinally extending L-shaped member 28 formed of a rigid material, having a first leg 30 and a second leg 32 at an angle to one another. The first leg 30 is connected to the upper surface 18 of the base member 16. The second leg 32 defines a first side wall 32 for disposition of the tool handle 12 thereagainst. The first leg 30 includes upper 34 and lower 36 surfaces and the second leg 32 includes inner 38 and outer 40 surfaces. The lower surface 36 of the first leg 30 is preferably permanently connected to the upper surface 18 of the base 16.

The tool handle receiver 24 further includes an elongated second side wall 42 generally corresponding in dimensions with the first side wall 32 and having inner 44 and outer 46 surfaces. The second side wall 42 is attached to at least one end 48 of the upper surface 34 of the first leg 30 to angle toward and away from the first side wall 32 and form an angled, generally U-shaped slot 26 between the side walls 32 and 42 in which the tool handle 13 can be received. The angle of the second side wall 42 relative to the first side wall 32 forms a larger, wider slot at a first end 50 of the tool handle receiver 24 and a smaller slot at an opposite end 52 of the tool handle receiver 24, such that a width W of the slot 26 varies over the length L of the tool handle receiver 24. This allows various sized tool handles to be disposed in and supported by the wrench stand 10.

In an exemplary embodiment, a first portion 54 of the second side wall 42, adjacent the first end 50, is rigidly connected to the tool handle receiver 24 via weld 55. A second portion 56 of the second side wall 42, adjacent the opposite end 52, is flexibly connected to the opposite end 52 of the tool handle receiver 24. The flexibility of the second portion 56 of the second side wall 42 enables a greater variety of shapes and sizes of tool handles 13 to be received at the opposite end. The flexibility of the second portion 56 also urges the tool handle 13 toward the first side wall 32 to securely support the tool 12 between the side walls 32 and 42.

If desired, the second portion 54 of the second side wall 42 may also be attached to the tool handle receiver 24, as for example via weld 57. Though the wrench stand 10 is illustrated herein as a welded assembly, the various components of the wrench stand 10 may be attached by any suitable combination of attachment devices and methods, for example by pins, bolts, spot welding or the like.

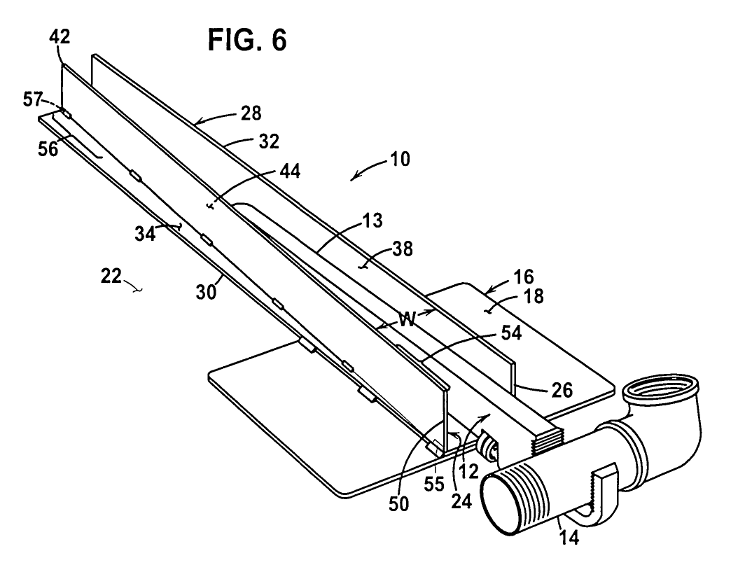

As illustrated in FIG. 6, larger tools having larger handles are receivable from the first end 50 of the slot 26 until the handle engages the inner surfaces 38 and 44 of the side walls 32 and 42. As illustrated in FIG. 1, smaller tools having smaller handles that are too small for the first end 50 are receivable in the opposite end 52 of the slot 26 so that the handle 13 immediately engages the inner surfaces 38 and 44 of the side walls 32 and 44. This allows, for example, the jaws of a smaller wrench to extend out of the tool handle receiver 24 and retain an associated part.

When the tool handle 13 is received in the slot 26, the upper surface 34 of the first leg 30 forms a lower resting surface for the handle 13 and the inner surfaces 38 and 44 of the side walls 32 and 42 form side resting surfaces for the handle 13. When these surfaces 32, 34 and 44 engage the tool handle 13, they retain and support the wrench to prevent slipping or tipping of the wrench.

The above described wrench stand 10 is directed to a stand formed with multiple welded metal members. However, it should be understood that the above described wrench stand 10 may be formed in a single piece that is injection molded using high strength plastic or cast using various metals. In such a case, the second side wall 42 would be integral with the tool handle receiver 24 and the tool handle receiver 24 would be integral with the base member 16.

It should also be understood that the wrench stand 10 can be used with other hand-tools such as adjustable wrenches, locking pliers, the like and their combinations.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A wrench stand for supporting a hand held tool in a use position, the stand comprising:
a laterally and longitudinally extending base member having an upper surface and a lower surface;
a first side wall rigidly attached to said base, said first side wall extending longitudinally relative to said base and projecting upwards from said upper surface of said base; and
a second side wall rigidly attached to said base, said second side wall extending longitudinally relative to said base and projecting upwards from said upper surface of said base,
wherein said first and second side walls form a longitudinally extending slot therebetween in which said tool can be disposed and supported in said use position.

2. The wrench stand of claim 1 wherein said second side wall angles toward and away from said first side wall to create a slot having a width which varies over a length of said slot allowing for various sized tool handles to be disposed in and supported by said wrench stand.

3. The wrench stand of claim 2 wherein said slot includes first and second slot openings at opposing ends of said slot, said first slot opening being wider than said second slot opening.

4. The wrench stand of claim 3 wherein said second side wall is rigidly attached to said base at a first end portion of said second side wall adjacent said first slot opening and flexibly attached to said base at a second end portion of said side wall adjacent said second slot opening, said flexibility of said second end portion enabling a greater variety of tool handles to be received at said second slot opening.

5. The wrench stand of claim 1 comprising a longitudinally extending L-shaped member having a first leg and a second leg, said first leg connected to said upper surface of said base member and said second leg defining said first side wall.

6. The wrench stand of claim 1 wherein said wrench stand is a welded assembly.

7. The wrench stand of claim 1 wherein said first and second side walls are integrally attached to said base member.

8. The wrench stand of claim 7 wherein said wrench stand is a single piece structure.

9. The wrench stand of claim 8 wherein said wrench stand is formed of one of injection molded plastic and cast metal.

10. The wrench stand of claim 1 wherein said base member lower surface is slip resistant.

11. The wrench stand of claim 10 wherein said base member lower surface is one of a machined or coated surface.

12. The wrench stand of claim 1 wherein said first and second side walls are non-parallel.

13. A wrench stand for supporting a hand-held tool in a use position, said stand comprising:
a laterally and longitudinally extending base member having an upper surface and a lower surface; and
an elongated, longitudinally extending tool-handle receiver disposed on said upper surface.

14. The wrench stand of claim 13, wherein said receiver includes first and second side walls extending from said base upper surface and defining a slot therebetween.

15. The wrench stand of claim 14 wherein said first and second side walls are non-parallel.

16. The wrench stand of claim 14 wherein said slot has a width that varies over a length of said slot.
